(19) United States
(12) Patent Application Publication
(10) Pub. No.: US 2025/0225092 A1
(43) Pub. Date: Jul. 10, 2025

(54) Systems And Methods For Communication Between Integrated Circuits Using Networks-On-Chip

(71) Applicant: Altera Corporation, San Jose, CA (US)

(72) Inventors: Scott Weber, Piedmont, CA (US); Rajiv Kumar, George Town (MY); Tara Shirvaikar, San Francisco, CA (US); Ilya Ganusov, San Jose, CA (US)

(73) Assignee: Altera Corporation, San Jose, CA (US)

(21) Appl. No.: 19/093,815

(22) Filed: Mar. 28, 2025

(51) Int. Cl. G06F 13/36

(52) U.S. Cl. CPC G06F 13/36; G06F 2213/40

(57) ABSTRACT

An integrated circuit includes a central region having logic circuits and networks-on-chip. Each of the networks-on-chip traverses the central region. The integrated circuit also includes an interface region having input and output buffer circuits. The networks-on-chip are configurable to exchange data between the logic circuits and the input and output buffer circuits. One of the networks-on-chip is configurable to place each source that receives the data from one of the logic circuits at one of multiple locations in the one of the networks-on-chip. The one of the networks-on-chip is also configurable to place each sink that provides the data to one of the logic circuits at one of the multiple locations in the one of the networks-on-chip. The input and output buffer circuits are coupled to exchange the data with an external device.

### BACKGROUND

Configurable integrated circuits can be configured by users to implement desired custom logic functions. In a typical scenario, a logic designer uses computer-aided design (CAD) tools to design a custom circuit design. When the design process is complete, the computer-aided design tools generate configuration data containing configuration bits. The configuration data is then loaded into configuration memory elements that configure configurable logic circuits in the integrated circuit to perform the functions of the custom circuit design. Configurable integrated circuits can be used for co-processing in big-data or fast-data applications. For example, configurable integrated circuits can be used for application acceleration tasks in a datacenter and can be reprogrammed during datacenter operation to perform different tasks.

### BRIEF DESCRIPTION OF DRAWINGS

FIG. 1 is a diagram that depicts an example of an integrated circuit (IC) that includes embedded fabric networks-on-chip (NOCs) in a fabric region of the IC.

FIGS. 2A-2C are diagrams that illustrate three integrated circuits (ICs) that are building blocks for the construction of an architecture of a circuit system that is equivalent to, or larger than, the high-level structure of the IC shown in FIG. 1.

FIG. 2D is a diagram that illustrates examples of an output buffer circuit and an input buffer circuit in an input/output circuit within an interface region.

FIGS. 3A-3C are diagrams that illustrate integrated circuits (ICs) that are coupled together to form three circuit systems.

FIGS. 4A-4B are diagrams that illustrate integrated circuits (ICs) that are coupled together to form two circuit systems.

FIG. 5 is a diagram illustrating a circuit system that includes two integrated circuits (ICs) that are coupled together through 2.5D interface regions in the ICs.

FIG. 6 is a diagram illustrating a circuit system that includes four integrated circuit (ICs) that are coupled together through 2.5D interface regions in the ICs.

FIG. 7 is a diagram that illustrates a circuit system that includes two ICs that are coupled together through 3 dimensional (3D) interface regions in the ICs.

FIG. 8 is a diagram that illustrates a circuit system that includes four ICs that are coupled together through 2.5D and 3D interface regions in the ICs.

FIG. 9 is a diagram that illustrates another circuit system that includes four ICs that are coupled together through 2.5D and 3D interface regions in the ICs.

FIG. 10 is a diagram that illustrates a circuit system that includes two ICs that are coupled together through 3 dimensional (3D) interface regions in the ICs.

FIG. 11 is a diagram that illustrates another circuit system that includes four ICs that are coupled together through 2.5D and 3D interface regions in the ICs.

FIG. 12 is a diagram that illustrates another circuit system that includes two ICs that are coupled together through a 3 dimensional (3D) interface.

FIG. 13 is a diagram that illustrates another circuit system that includes two ICs that are coupled together through a 3D interface.

FIG. 14 is a diagram that illustrates another circuit system that includes two ICs that are coupled together through a 3D interface.

FIG. 15 is a diagram that illustrates another circuit system that includes two ICs that are coupled together through a 3D interface.

FIG. 16 is a diagram that illustrates a circuit system that includes 6 ICs that are coupled together through 2.5D and 3D interface regions in the ICs.

FIG. 17 is a diagram of an illustrative example of a configurable integrated circuit (IC).

FIG. 18A illustrates a block diagram of a system that can be used to implement a circuit design to be programmed into a programmable logic device using design software.

FIG. 18B is a diagram that depicts an example of a programmable logic device that includes fabric dies and base dies that are connected to one another via microbumps.

FIG. 19 is a block diagram illustrating a computing system configured to implement one or more aspects of the embodiments described herein.

### DETAILED DESCRIPTION

A configurable integrated circuit (IC) can include a fabric region that has several groups of configurable logic circuit blocks and one or more networks-on-chip (NOCs) that are adjacent to one or more edges of the fabric region. The NOCs are used to route data between the fabric region and on-chip or off-chip circuits. A configurable IC can be coupled to other integrated circuits through external conductors.

According to some examples disclosed herein, a circuit system includes two or more integrated circuits (ICs) that are coupled together through external conductors. The ICs in the circuit system can, as examples, be coupled together through external conductors configured in 2.5 dimensional (2.5D) or 3 dimensional (3D) assemblies. Each of the integrated circuits (ICs) in the circuit system includes a central region and embedded networks-on-chip (NOCs) that cross the central region of the IC. The central region of each of the ICs can include configurable logic circuit blocks or non-configurable circuitry that is designed, as an example, to function as an accelerator. Each of the ICs can also include one or more networks-on-chip (NOCs) that are adjacent to one or more edges of the central region.

According to additional examples disclosed herein, the NOCs and the embedded NOCs in two or more ICs in the circuit system are coupled together through interface regions in the ICs and through external conductors that couple together the interface regions. The external conductors can, as examples, couple together the ICs in 2.5D and/or 3D assemblies. In these examples, the NOCs and the embedded NOCs create connectivity layers that extend across the ICs in the circuit system that are arranged in 2.5D and/or 3D assemblies. The NOCs and the embedded NOCs in each of the ICs are coupled to one or more interface regions at one or more edges of the IC. The interface regions in each IC transmit data between the NOCs and the embedded NOCs in multiple ICs through the external conductors. Further details of various embodiments of these circuit systems and methods are disclosed herein below.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs). As discussed herein, an integrated circuit (IC) can include hard logic and/or soft logic. The circuits in an integrated circuit device (e.g., in a configurable logic IC) that are configurable by an end user are referred to as “soft logic.” “Hard logic” generally refers to circuits in an integrated circuit device that have substantially less configurable features than soft logic or no configurable features.

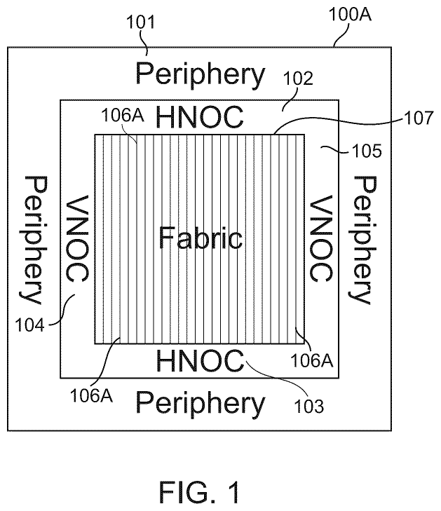

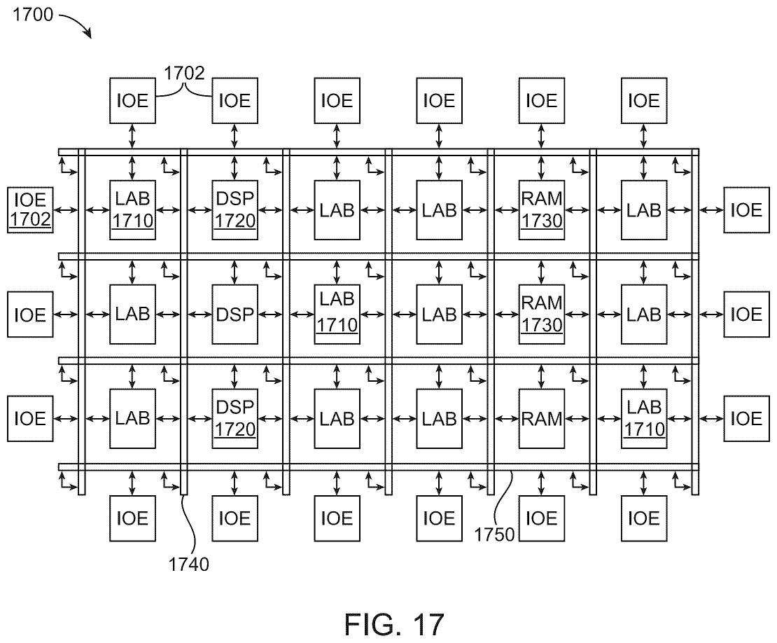

FIG. 1 is a diagram that depicts an example of an integrated circuit (IC) 100A that includes a periphery region 101, horizontal networks-on-chip (HNOCs) 102-103, vertical networks-on-chip (VNOCs) 104-105, and a fabric region 107. The fabric region 107 includes embedded fabric networks-on-chip (NOCs) 106A. The fabric region 107 is a central region of the IC 100A. The fabric region 107 includes soft logic (i.e., configurable logic circuits), digital signal processing circuits, and/or memory circuits that are not shown in FIG. 1, but are shown, for example, in FIG. 17. The fabric region 107 can also, or alternatively, include hard logic. The IC 100A of Figure (FIG. 1 and the other ICs disclosed herein can be any types of integrated circuits (ICs), such as configurable ICs (e.g., a field programmable gate arrays (FPGAs) or programmable logic devices), microprocessor ICs, graphics processing unit ICs, memory ICs, application specific ICs, transceiver ICs, memory ICs, etc.

The horizontal networks-on-chip (NOCs) 102-103 are adjacent to the top and bottom edges of the fabric region 107, and the vertical NOCs 104-105 are adjacent to the left and right edges of the fabric region 107. The NOCs 102-105 are routing paths that include switches and conductors that route data between the fabric region 107 and the periphery region 101. The NOCs 102-105 can route data to external devices via the periphery region 101 and/or to and from the fabric region 107.

FIG. 1 depicts 24 embedded fabric NOCs 106A as vertical lines that traverse the entire length of the fabric region 107 as an example. According to various examples, ICs can include any number of embedded fabric NOCs arranged in any suitable manner across the fabric regions. The embedded fabric NOCs 106A are high-bandwidth hardened data paths between the NOCs 102-105 and the circuits in fabric region 107. Each of the embedded fabric NOCs 106A extends across the entire length of the fabric region 107 as shown in FIG. 1. The embedded fabric NOCs 106A allow data traffic on the NOCs 102-105 to be forwarded deep into the fabric region 107. The fabric memory circuits are used as buffers that support the embedded fabric NOCs 106A being utilized for both hardened memory data transport between external and on-chip memory circuits and ubiquitous interface bridge creation throughout the fabric region 107. This interface can be, for example, an Advanced Extensible Interface (AXI). The embedded fabric NOCs 106A allow efficient use of resources in the fabric region 107 by avoiding routing congestion, because the embedded fabric NOCs 106A can operate at a higher frequency (e.g., twice the frequency) than the circuits in the fabric region 107.

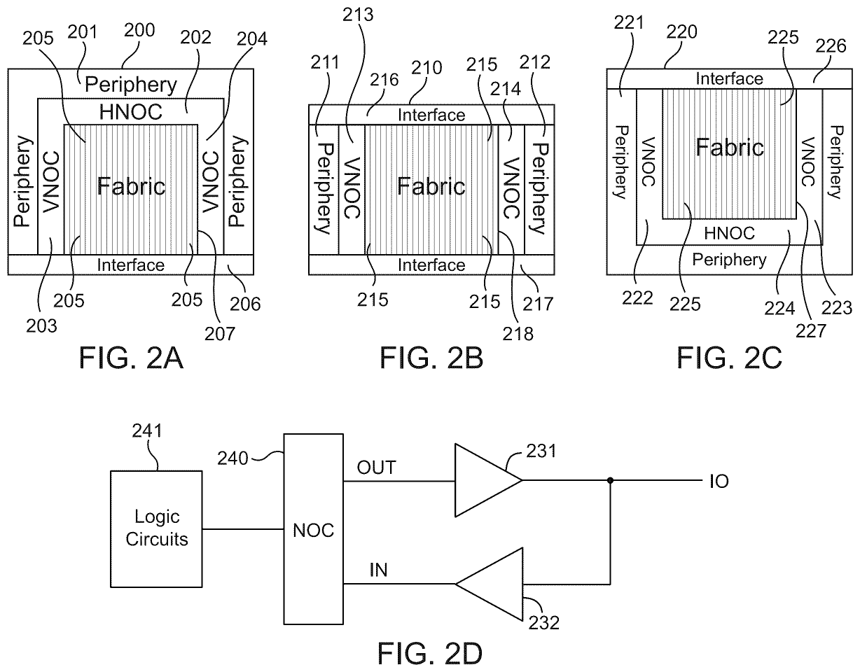

FIGS. 2A-2C are diagrams that illustrate three integrated circuits (ICs) that are building blocks for the construction of an architecture for a circuit system that is equivalent to, or larger than, the high-level structure of the IC 100A shown in FIG. 1. Each of the ICs shown in FIGS. 2A-2C is a separate IC die. Each of the ICs shown in FIGS. 2A-2C includes an interface region that includes input and output (IO) buffers, drivers, and/or receivers that drive and receive signals to allow coupling the monolithic ICs together to build a circuit system that is a larger version of the IC 100A of FIG. 1.

FIG. 2A illustrates an example of an integrated circuit 200 that includes a periphery region 201, horizontal networks-on-chip (HNOCs) 202, vertical NOCs (VNOCs) 203-204, fabric region 207, and interface region 206 next to a side of IC 200 and next to an edge of fabric region 207. The fabric region 207 includes embedded fabric networks-on-chip (NOCs) 205, which are shown as parallel vertical lines within fabric region 207. The embedded fabric NOCs 205 are parallel to each other and traverse the length of fabric region 207. Each of the embedded fabric NOCs 205 is coupled to input and output buffer circuits in the interface region 206.

FIG. 2B illustrates an example of an integrated circuit 210 that includes a fabric region 218, two vertical NOCs (VNOCs) 213-214 adjacent to two edges of fabric region 218, two periphery regions 211-212 adjacent to VNOCs 213-214, and interface regions 216-217 next to 2 sides of IC 210 and next to edges of fabric region 218. The fabric region 218 includes embedded fabric networks-on-chip (NOCs) 215, which are shown as parallel vertical lines within fabric region 218. The embedded fabric NOCs 215 are parallel to each other and traverse the length of fabric region 218. Each of the embedded fabric NOCs 215 is coupled to input and output buffer circuits in each of the interface regions 216 and 217.

FIG. 2C illustrates an example of an integrated circuit 220 that includes a fabric region 227, a horizontal network-on-chip (HNOC) 224 adjacent to one side of the fabric region 227, vertical NOCs (VNOCs) 222 and 223 adjacent to two sides of fabric region 227, a periphery region 221 adjacent to NOCs 222-224, and an interface region 226 next to a side of IC 220 and next to an edge of fabric region 227. The fabric region 227 includes embedded fabric networks-on-chip (NOCs) 225, which are shown as parallel vertical lines within fabric region 227. The embedded fabric NOCs 225 are parallel to each other and traverse the length of fabric region 227. Each of the embedded fabric NOCs 225 is coupled to input and output buffer circuits in the interface region 226. Each of the ICs 200, 210, and 220 is a separate IC die. As examples, each of the fabric regions 207, 218, and 227 can include soft logic (e.g., configurable logic circuit blocks), memory circuits, and/or optionally digital signal processing circuit blocks, as disclosed herein, for example, with respect to FIG. 17. As another example, each of the fabric regions 207, 218, and 227 can also, or alternatively, include hard logic circuits.

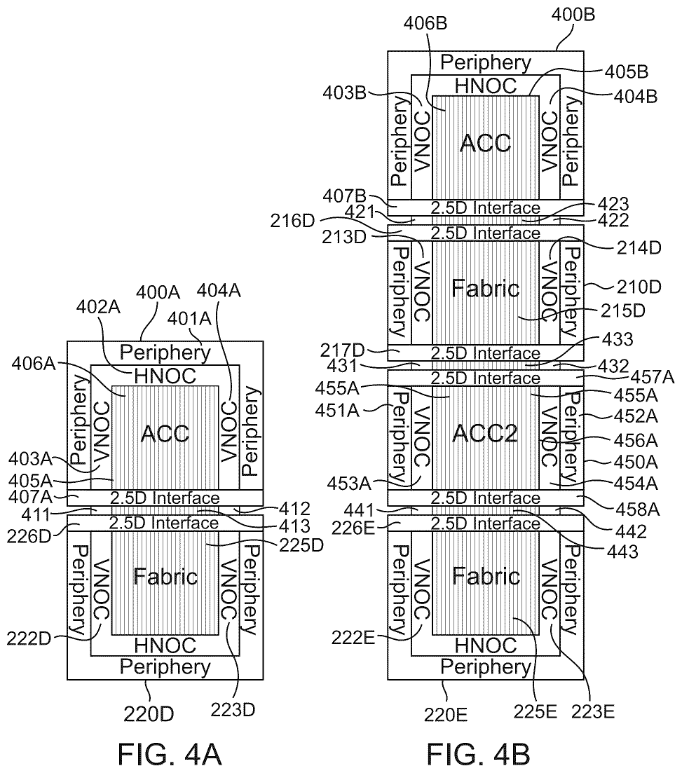

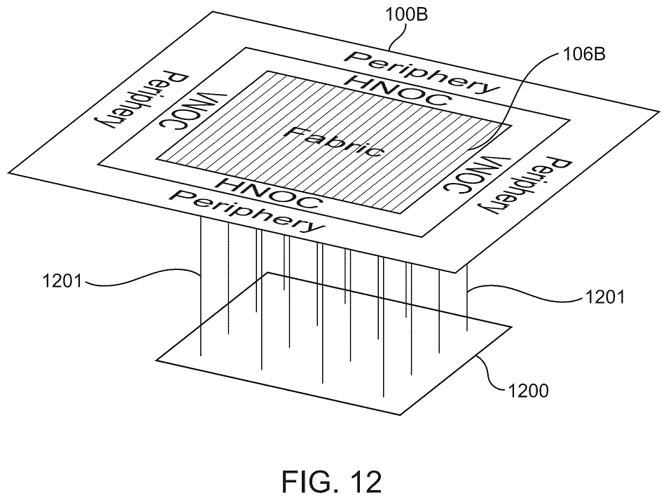

FIG. 2D is a diagram that illustrates examples of an output buffer circuit 231 and an input buffer circuit 232 in an input/output circuit within each of the 2.5D and 3D interface regions disclosed herein, for example, with respect to FIGS. 2A-2C, 3A-3C, 4A-4B, 5-11, and 16. The input of output buffer circuit 231 is coupled to an embedded network-on-chip (NOC) 240, and the output of input buffer circuit 232 is coupled to the embedded NOC 240. The embedded NOC 240 can be any, some, or all of the embedded fabric NOCs (e.g., NOCs, 205, 215, and/or 225) in a fabric region of an IC disclosed herein and/or any the embedded NOCs in the accelerator circuits of FIGS. 4A-4b, 5, 6, 9, 10, 11, and 16, as disclosed herein below. The embedded NOC 240 is configurable to exchange data between logic circuits 241 and the input and output buffer circuits 231-232. The output buffer circuit 231 and the input buffer circuit 232 can exchange data and other information with logic circuits 241 (e.g., soft logic and/or hard logic) in the fabric or accelerator region of the IC through the embedded NOC 240. The buffer circuits 231-232 and the embedded NOC 240 can exchange data and other information between the logic circuits 241 in the fabric or accelerator region of the IC and an external IC. The embedded NOC 240 is configurable to place each source that receives data from one of the logic circuits 241 at one of multiple locations in the embedded NOC 240. The embedded NOC 240 is also configurable to place each sink that provides data to one of the logic circuits at one of the multiple locations in the embedded NOC 240. Each of the 2.5D and 3D interface regions shown in these figures can include several of the output and input buffer circuits 231-232 shown in FIG. 2D. The ICs disclosed herein with respect to FIGS. 12-16 can include the input and output buffer circuits 231-232 of FIG. 2D in the fabric regions or in the accelerator circuits.

Each pair of the output and input buffer circuits 231-232 (or more) are coupled to one of the NOCs in the IC. Output buffer circuit 231 drives data indicated by an output signal OUT from an embedded fabric NOC, a VNOC, or an HNOC to an external conductor outside the integrated circuit as signal IO. Input buffer circuit 232 receives data in signal IO from an external conductor that is outside the integrated circuit and drives the data to an embedded fabric NOC, a VNOC, or an HNOC as signal IN. The output buffer circuit 231 and the input buffer circuit 232 are enabled and disabled to operate at different times.

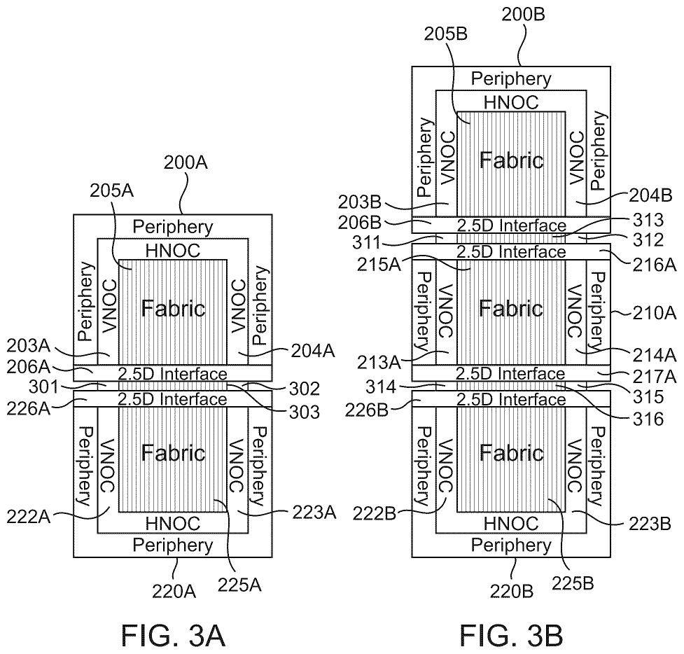

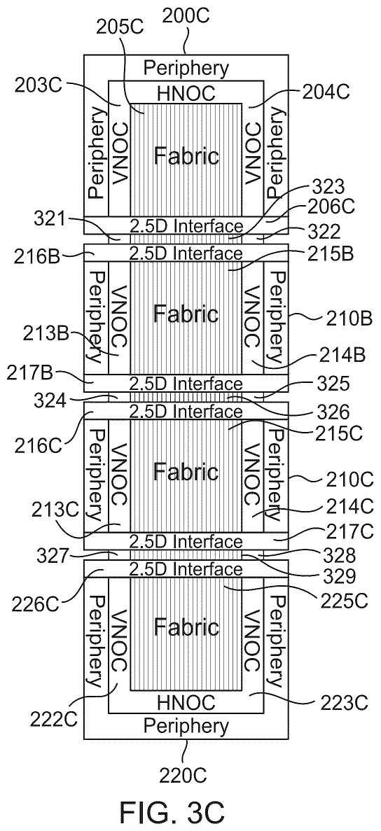

FIGS. 3A-3C are diagrams that illustrate integrated circuits (ICs) that are coupled together to form three circuit systems. Each of these three circuit systems is equivalent to, or larger than, the high-level structure of the IC 100A shown in FIG. 1. FIG. 3A is a diagram that illustrates a circuit system that includes two integrated circuits (ICs) 200A and 220A that are coupled together through 2.5D interface regions in the ICs. IC 200A is an instance of IC 200 of FIG. 2A, and IC 220A is an instance of IC 220 of FIG. 2C. The VNOC 203A in IC 200A and the VNOC 222A in IC 220A can exchange data (i.e., transmit and receive data between each other) through a first set of input and output (IO) buffer circuits in 2.5 dimensional (2.5D) interface region 206A, external conductors 301, and a first set of IO buffer circuits in 2.5D interface region 226A. The embedded fabric NOCs 205A in IC 200A and the embedded fabric NOCs 225A in IC 220A can exchange data (i.e., transmit and receive data between each other) through a second set of IO buffer circuits in 2.5D interface region 206A, external conductors 303, and a second set of IO buffer circuits in 2.5D interface region 226A. The VNOC 204A in IC 200A and the VNOC 223A in IC 220A can exchange data (i.e., transmit and receive data between each other) through a third set of IO buffer circuits in 2.5D interface region 206A, external conductors 302, and a third set of IO buffer circuits in 2.5D interface region 226A.

FIG. 3B is a diagram that illustrates a circuit system that includes three integrated circuits (ICs) 200B, 210A, and 220B that are coupled together through 2.5D interface regions in the ICs. IC 200B is another instance of IC 200 of FIG. 2A, IC 210A is an instance of IC 210 of FIG. 2B, and IC 220B is another instance of IC 220 of FIG. 2C. The VNOC 203B in IC 200B and the VNOC 213A in IC 210A can exchange data with each other through a first set of input and output (IO) buffer circuits in 2.5 dimensional (2.5D) interface region 206B, external conductors 311, and a first set of IO buffer circuits in 2.5D interface region 216A. The embedded fabric NOCs 205B in IC 200B and the embedded fabric NOCs 215A in IC 210A can exchange data with each other through a second set of IO buffer circuits in 2.5D interface region 206B, external conductors 313, and a second set of IO buffer circuits in 2.5D interface region 216A. The VNOC 204B in IC 200B and the VNOC 214A in IC 210A can exchange data with each other through a third set of IO buffer circuits in 2.5D interface region 206B, external conductors 312, and a third set of IO buffer circuits in 2.5D interface region 216A.

The VNOC 222B in IC 220B and the VNOC 213A in IC 210A can exchange data with each other through a first set of IO buffer circuits in 2.5D interface region 226B, external conductors 314, and a first set of IO buffer circuits in 2.5D interface region 217A. The embedded fabric NOCs 225B in IC 220B and the embedded fabric NOCs 215A in IC 210A can exchange data with each other through a second set of IO buffer circuits in 2.5D interface region 226B, external conductors 316, and a second set of IO buffer circuits in 2.5D interface region 217A. The VNOC 223B in IC 220B and VNOC 214A in IC 210A can exchange data with each other through a third set of IO buffer circuits in 2.5D interface region 226B, external conductors 315, and a third set of IO buffer circuits in 2.5D interface region 217A.

FIG. 3C is a diagram that illustrates a circuit system that includes four integrated circuits (ICs) 200C, 210B, 210C, and 220C that are coupled together through 2.5D interface regions in the ICs. IC 200C is another instance of IC 200 of FIG. 2A, ICs 210B-210C are instances of IC 210 of FIG. 2B, and IC 220C is another instance of IC 220 of FIG. 2C. The VNOC 203C in IC 200C and the VNOC 213B in IC 210B can exchange data with each other through a first set of input and output (IO) buffer circuits in 2.5D interface region 206C, external conductors 321, and a first set of IO buffer circuits in 2.5D interface region 216B. The embedded fabric NOCs 205C in IC 200C and the embedded fabric NOCs 215B in IC 210B can exchange data with each other through a second set of IO buffer circuits in 2.5D interface region 206C, external conductors 323, and a second set of IO buffer circuits in 2.5D interface region 216B. The VNOC 204C in IC 200C and the VNOC 214B in IC 210B can exchange data with each other through a third set of IO buffer circuits in 2.5D interface region 206C, external conductors 322, and a third set of IO buffer circuits in 2.5D interface region 216B.

The VNOC 213C in IC 210C and the VNOC 213B in IC 210B can exchange data with each other through a first set of input and output (IO) buffer circuits in 2.5D interface region 217B, external conductors 324, and a first set of IO buffer circuits in 2.5D interface region 216C. The embedded fabric NOCs 215C in IC 210C and the embedded fabric NOCs 215B in IC 210B can exchange data with each other through a second set of IO buffer circuits in 2.5D interface region 217B, external conductors 326, and a second set of IO buffer circuits in 2.5D interface region 216C. The VNOC 214C in IC 210C and the VNOC 214B in IC 210B can exchange data with each other through a third set of IO buffer circuits in 2.5D interface region 217B, external conductors 325, and a third set of IO buffer circuits in 2.5D interface region 216C.

The VNOC 222C in IC 220C and the VNOC 213C in IC 210C can exchange data with each other through a first set of IO buffer circuits in 2.5D interface region 226C, external conductors 327, and a first set of IO buffer circuits in 2.5D interface region 217C. The embedded fabric NOCs 225C in IC 220C and the embedded fabric NOCs 215C in IC 210C can exchange data with each other through a second set of IO buffer circuits in 2.5D interface region 226C, external conductors 329, and a second set of IO buffer circuits in 2.5D interface region 217C. The VNOC 223C in IC 220C and the VNOC 214C in IC 210C can exchange data with each other through a third set of IO buffer circuits in 2.5D interface region 226C, external conductors 328, and a third set of IO buffer circuits in 2.5D interface region 217C.

FIGS. 4A-4B are diagrams that illustrate integrated circuits (ICs) that are coupled together to form two circuit systems. Each of the ICs of FIGS. 4A-4B is a separate die. FIG. 4A is a diagram illustrating a circuit system that includes two integrated circuits (ICs) 400A and 220D that are coupled together through 2.5D interface regions in the ICs. IC 220D is another instance of IC 220 of FIG. 2C.

Integrated circuit 400A includes a periphery region 401A, horizontal network-on-chip (HNOC) 402A, vertical NOCs (VNOCs) 403A and 404A, an accelerator region (ACC) 405A, and 2.5 dimensional (2.5D) interface region 407A. The accelerator region 405A is an accelerator circuit. An accelerator circuit as used herein can be any circuit that transmits and receives data and other communications through an embedded network-on-chip (NOC) in an IC. An accelerator circuit as used herein can be in any type of IC, such as a configurable IC, a processor IC, a memory IC, etc. As an example that is not intended to be limiting, any of the accelerator circuits disclosed herein can include configurable logic circuits/or non-configurable logic circuits that are configured and/or designed to perform acceleration functions, for example, as a co-processor for another external processor IC. The accelerator region 405A includes embedded networks-on-chip (NOCs) 406A, which are shown as vertical lines within accelerator region 405A. The embedded NOCs 406A are parallel to each other and traverse the length of accelerator region 405A. Each of the embedded NOCs 406A is coupled to input and output buffer circuits in the 2.5D interface region 407A.

The VNOCs 403A and 404A of IC 400A, the VNOCs 222D and 223D of IC 220D, and/or the embedded NOCs 406A of IC 400A and the embedded NOCs 225D of IC 220D are used to extend connectivity between the IC dies 400A and 220D. The VNOC 403A in IC 400A and the VNOC 222D in IC 220D can exchange data through a first set of input and output (IO) buffer circuits in 2.5D interface region 407A, external conductors 411, and a first set of IO buffer circuits in 2.5D interface region 226D. The embedded NOCs 406A in IC 400A and the embedded fabric NOCs 225D in IC 220D can exchange data through a second set of IO buffer circuits in 2.5D interface region 407A, external conductors 413, and a second set of IO buffer circuits in 2.5D interface region 226D. The VNOC 404A in IC 400A and the VNOC 223D in IC 220D can exchange data through a third set of IO buffer circuits in 2.5D interface region 407A, external conductors 412, and a third set of IO buffer circuits in 2.5D interface region 226D.

FIG. 4B is a diagram illustrating a circuit system that includes four integrated circuits (ICs) 400B, 210D, 450A, and 220E that are coupled together through 2.5D interface regions in the ICs. IC 400B is an instance of the IC 400A of FIG. 4A, IC 210D is another instance of IC 210 of FIG. 2B, and IC 220E is another instance of IC 220 of FIG. 2C.

Integrated circuit (IC) 450A includes periphery regions 451A and 452A, vertical NOCs (VNOCs) 453A and 454A, an accelerator region (ACC2) 456A, and 2.5 dimensional (2.5D) interface regions 457A-458A. The accelerator region 456A includes embedded networks-on-chip (NOCs) 455A, which are shown as vertical lines within accelerator region 456A. The embedded NOCs 455A are parallel to each other and traverse the length of accelerator region 456A. Each of the embedded NOCs 455A is coupled to input and output buffer circuits in each of the 2.5D interface regions 457A and 458A. The accelerator region 456A includes an accelerator circuit that is in communication with embedded NOCs 455A.

The VNOC 403B in IC 400B and the VNOC 213D in IC 210D can exchange data with each other through a first set of input and output (IO) buffer circuits in 2.5D interface region 407B, external conductors 421, and a first set of IO buffer circuits in 2.5D interface region 216D. The embedded NOCs 406B in accelerator region 405B in IC 400B and the embedded fabric NOCs 215D in IC 210D can exchange data with each other through a second set of IO buffer circuits in 2.5D interface region 407B, external conductors 423, and a second set of IO buffer circuits in 2.5D interface region 216D. The VNOC 404B in IC 400B and the VNOC 214D in IC 210D can exchange data with each other through a third set of IO buffer circuits in 2.5D interface region 407B, external conductors 422, and a third set of IO buffer circuits in 2.5D interface region 216D.

The VNOC 213D in IC 210D and the VNOC 453A in IC 450A can exchange data with each other through a first set of IO buffer circuits in 2.5D interface region 217D, external conductors 431, and a first set of IO buffer circuits in 2.5D interface region 457A. The embedded fabric NOCs 215D in IC 210D and the embedded NOCs 455A in IC 450A can exchange data with each other through a second set of IO buffer circuits in 2.5D interface region 217D, external conductors 433, and a second set of IO buffer circuits in 2.5D interface region 457A. The VNOC 214D in IC 210D and the VNOC 454A in IC 450A can exchange data with each other through a third set of IO buffer circuits in 2.5D interface region 217D, external conductors 432, and a third set of IO buffer circuits in 2.5D interface region 457A.

The VNOC 453A in IC 450A and the VNOC 222E in IC 220E can exchange data with each other through a first set of IO buffer circuits in 2.5D interface region 226E, external conductors 441, and a first set of IO buffer circuits in 2.5D interface region 458A. The embedded fabric NOCs 225E in IC 220E and the embedded NOCs 455A in accelerator region 456A in IC 450A can exchange data with each other through a second set of IO buffer circuits in 2.5D interface region 458A, external conductors 443, and a second set of IO buffer circuits in 2.5D interface region 226E. The VNOC 223E in IC 220E and the VNOC 454A in IC 450A can exchange data with each other through a third set of IO buffer circuits in 2.5D interface region 226E, external conductors 442, and a third set of IO buffer circuits in 2.5D interface region 458A.

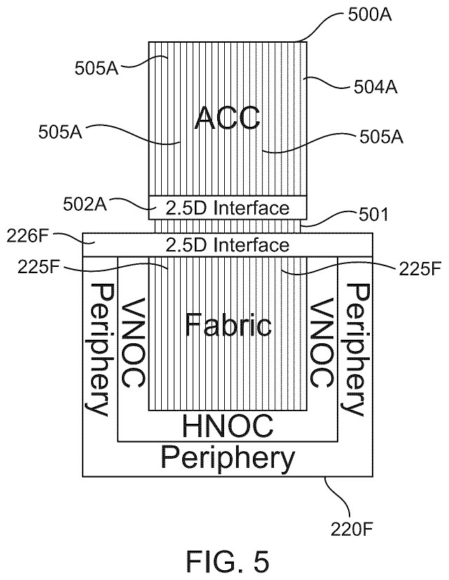

FIG. 5 is a diagram illustrating a circuit system that includes two integrated circuits (ICs) 500A and 220F that are coupled together through 2.5D interface regions in the ICs. IC 220F is another instance of IC 220 of FIG. 2C. IC 500A includes an accelerator circuit (ACC) 504A and 2.5 dimensional (2.5D) interface region 502A. The accelerator circuit 504A includes embedded NOCs 505A, which are shown as vertical lines within accelerator circuit 504A. The embedded NOCs 505A are parallel to each other and cross the length of accelerator circuit 504A. Each of the embedded NOCs 505A is coupled to input and output buffer circuits in the 2.5D interface region 502A. IC 500A does not include HNOCs, VNOCs, or a periphery region. Logic circuits in the accelerator circuit 504A are in communication with the embedded NOCs 505A. The embedded NOCs 505A in accelerator circuit 504A in IC 500A and the embedded fabric NOCs 225F in IC 220F can exchange data with each other through IO buffer circuits in 2.5D interface region 502A, external conductors 501, and IO buffer circuits in 2.5D interface region 226F.

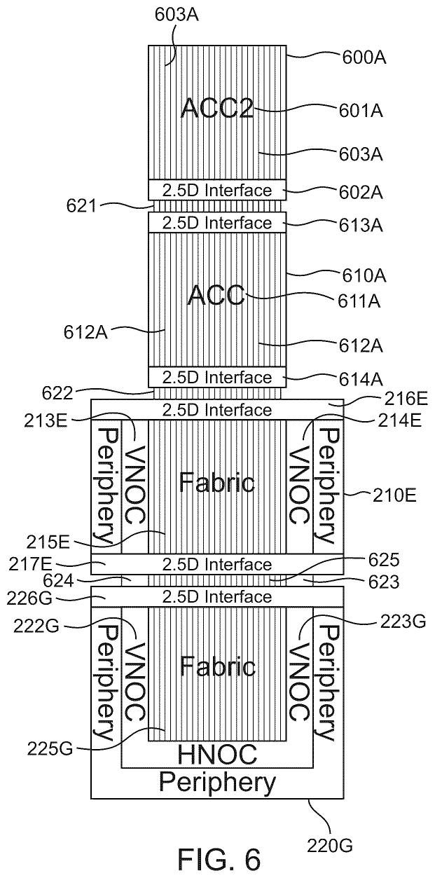

FIG. 6 is a diagram illustrating a circuit system that includes four integrated circuits (ICs) 600A, 610A, 210E, and 220G that are coupled together through 2.5D interface regions in the ICs. IC 210E is another instance of IC 210 of FIG. 2B, and IC 220G is another instance of IC 220 of FIG. 2C. IC 600A includes an accelerator circuit (ACC2) 601A and 2.5D interface region 602A. The accelerator circuit 601A includes embedded NOCs 603A shown as vertical lines in FIG. 6. Each of the embedded NOCs 603A is coupled to input and output (IO) buffer circuits in the 2.5D interface region 602A. IC 600A does not include HNOCs, VNOCs, or a periphery region.

IC 610A includes another accelerator circuit 611A (ACC) and 2.5D interface regions 613A and 614A. The accelerator circuit 611A includes embedded NOCs 612A shown as vertical lines in FIG. 6. Each of the embedded NOCs 612A is coupled to IO buffer circuits in each of the 2.5D interface regions 613A and 614A. IC 610A does not include HNOCs, VNOCs, or a periphery region. Logic circuits in the accelerator circuits 601A and 611A are in communication with the embedded NOCs 603A and 612A, respectively.

The embedded NOCs 603A in accelerator circuit 601A in IC 600A and the embedded NOCs 612A in accelerator circuit 611A in IC 610A can exchange data with each other through IO buffer circuits in 2.5D interface region 602A, external conductors 621, and IO buffer circuits in 2.5D interface region 613A. The embedded NOCs 215E in IC 210E and the embedded NOCs 612A in accelerator circuit 611A in IC 610A can exchange data with each other through IO buffer circuits in 2.5D interface region 614A, external conductors 622, and IO buffer circuits in 2.5D interface region 216E.

The VNOC 222G in IC 220G and the VNOC 213E in IC 210E can exchange data with each other through a first set of IO buffer circuits in 2.5D interface region 226G, external conductors 624, and a first set of IO buffer circuits in 2.5D interface region 217E. The embedded fabric NOCs 225G in IC 220G and the embedded fabric NOCs 215E in IC 210E can exchange data with each other through a second set of IO buffer circuits in 2.5D interface region 226G, external conductors 625, and a second set of IO buffer circuits in 2.5D interface region 217E. The VNOC 223G in IC 220G and the VNOC 214E in IC 210E can exchange data with each other through a third set of IO buffer circuits in 2.5D interface region 226G, external conductors 623, and a third set of IO buffer circuits in 2.5D interface region 217E.

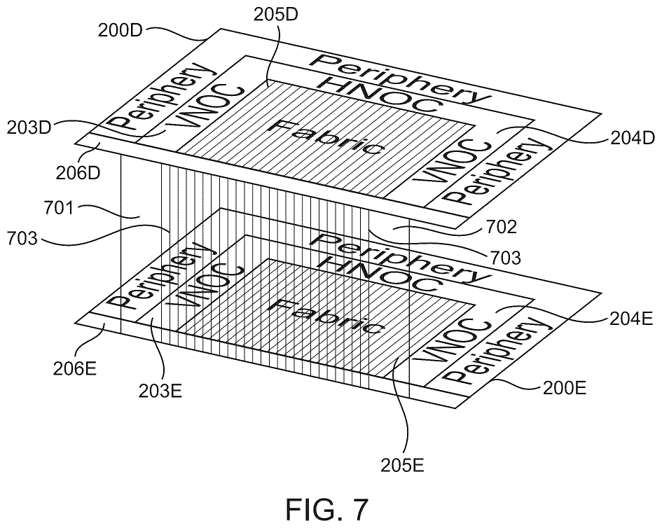

FIG. 7 is a diagram that illustrates a circuit system that includes two integrated circuits (ICs) 200D and 200E that are coupled together through 3 dimensional (3D) interface regions in the ICs. IC 200D and IC 200E are additional instances of IC 200 of FIG. 2A with 3D interface regions, instead of 2.5D interface regions. The circuit system of FIG. 7 includes vertical external conductors 701-703 that couple together ICs 200D and 200E along one edge of each of ICs 200D and 200E in a 3D folded book arrangement. The VNOC 203D in IC 200D and the VNOC 203E in IC 200E can exchange data with each other through a first set of input and output (IO) buffer circuits in 3D interface region 206D, vertical external conductors 701, and a first set of IO buffer circuits in 3D interface region 206E. The embedded fabric NOCs 205D in IC 200D and the embedded fabric NOCs 205E in IC 200E can exchange data with each other through a second set of IO buffer circuits in 3D interface region 206D, vertical external conductors 703, and a second set of IO buffer circuits in 3D interface region 206E. The VNOC 204D in IC 200D and the VNOC 204E in IC 200E can exchange data with each other through a third set of IO buffer circuits in 3D interface region 206D, vertical external conductors 702, and a third set of IO buffer circuits in 3D interface region 206E.

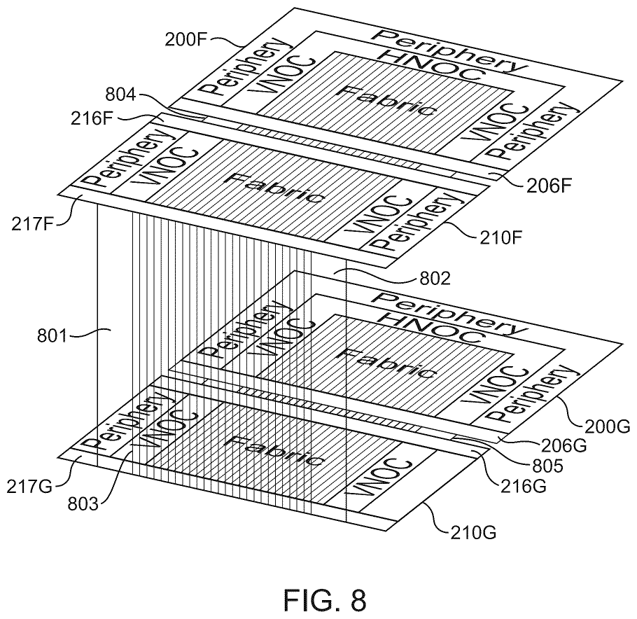

FIG. 8 is a diagram that illustrates a circuit system that includes four integrated circuits (ICs) 200F, 210F, 210G, and 200G that are coupled together through 2.5D and 3D interface regions in the ICs. IC 200F and IC 200G are additional instances of IC 200 of FIG. 2A with 2.5D interface regions. ICs 210F and 210G are additional instances of IC 210 of FIG. 2B with 2.5D and 3D interface regions. The circuit system of FIG. 8 includes vertical external conductors 801-803 that couple together ICs 210F and 210G along edges of ICs 210F and 210G in a 3D folded book arrangement.

The VNOCs in ICs 200F and 210F can exchange data with each other through IO buffer circuits in 2.5D interface regions 206F and 216F and external conductors 804, as disclosed herein with respect to previous embodiments. The embedded fabric NOCs in ICs 200F and 210F can exchange data with each other through IO buffer circuits in 2.5D interface regions 206F and 216F and external conductors 804, as disclosed herein with respect to previous embodiments.

The VNOCs in ICs 210F and 210G can exchange data with each other through IO buffer circuits in 3D interface regions 217F and 217G and vertical external conductors 801-802. The embedded fabric NOCs in ICs 210F and 210G can exchange data with each other through IO buffer circuits in 3D interface regions 217F and 217G and vertical external conductors 803.

The VNOCs in ICs 200G and 210G can exchange data with each other through IO buffer circuits in 2.5D interface regions 206G and 216G and external conductors 805, as disclosed herein with respect to previous embodiments. The embedded fabric NOCs in ICs 200G and 210G can exchange data with each other through IO buffer circuits in 2.5D interface regions 206G and 216G and external conductors 805, as disclosed herein with respect to previous embodiments.

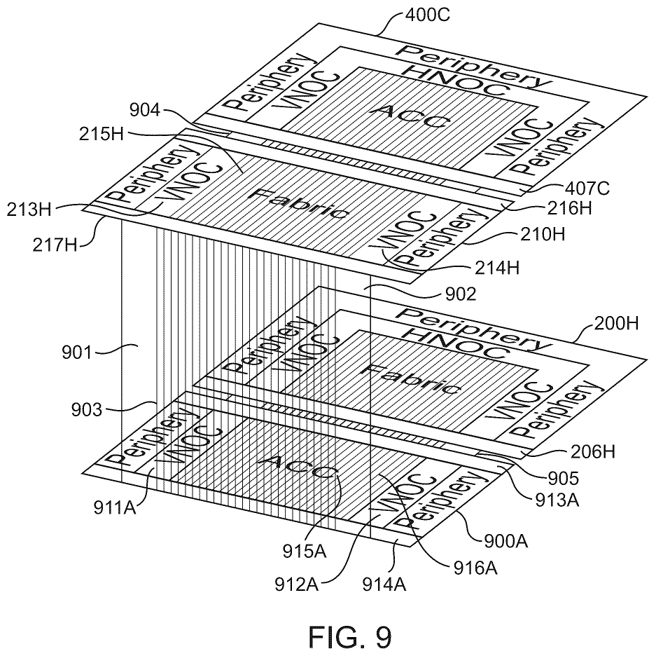

FIG. 9 is a diagram that illustrates a circuit system that includes four integrated circuits (ICs) 400C, 210H, 900A, and 200H that are coupled together through 2.5D and 3D interface regions in the ICs. IC 200H is an additional instance of IC 200 of FIG. 2A with 2.5D interface regions. IC 210H is an additional instance of IC 210 of FIG. 2B with 2.5D and 3D interface regions. IC 400C is an additional instance of IC 400A of FIG. 4A. IC 900A is an IC with periphery regions, VNOCs 911A and 912A, 2.5D interface region 913A, 3D interface region 914A, and an accelerator circuit 915A having embedded NOCs 916A that traverse the length of the accelerator circuit 915A. The circuit system of FIG. 9 includes vertical external conductors 901-903 that couple together ICs 210H and 900A along edges of ICs 210H and 900A in a 3D folded book arrangement.

The VNOCs in ICs 400C and 210H can exchange data with each other through IO buffer circuits in 2.5D interface regions 407C and 216H and external conductors 904, as disclosed herein with respect to FIG. 4B. The embedded NOCs in ICs 400C and 210H can exchange data with each other through IO buffer circuits in 2.5D interface regions 407C and 216H and external conductors 904, as disclosed herein with respect to FIG. 4B.

The VNOC 213H in IC 210H and the VNOC 911A in IC 900A can exchange data with each other through a first set of IO buffer circuits in 3D interface region 217H, vertical external conductors 901, and a first set of IO buffer circuits in 3D interface region 914A. The embedded fabric NOCs 215H in the fabric region of IC 210H and the embedded NOCs 916A in IC 900A can exchange data with each other through a second set of IO buffer circuits in 3D interface region 217H, vertical external conductors 903, and a second set of IO buffer circuits in 3D interface region 914A. The VNOC 214H in IC 210H and the VNOC 912A in IC 900A can exchange data with each other through a third set of IO buffer circuits in 3D interface region 217H, vertical external conductors 902, and a third set of IO buffer circuits in 3D interface region 914A.

The VNOCs in ICs 900A and 200H can exchange data with each other through IO buffer circuits in 2.5D interface regions 206H and 913A and external conductors 905, as disclosed herein with respect to previous embodiments. The embedded NOCs 916A in IC 900A and the embedded fabric NOCs in IC 200H can exchange data with each other through IO buffer circuits in 2.5D interface regions 206H and 913A and external conductors 905, as disclosed herein with respect to previous embodiments.

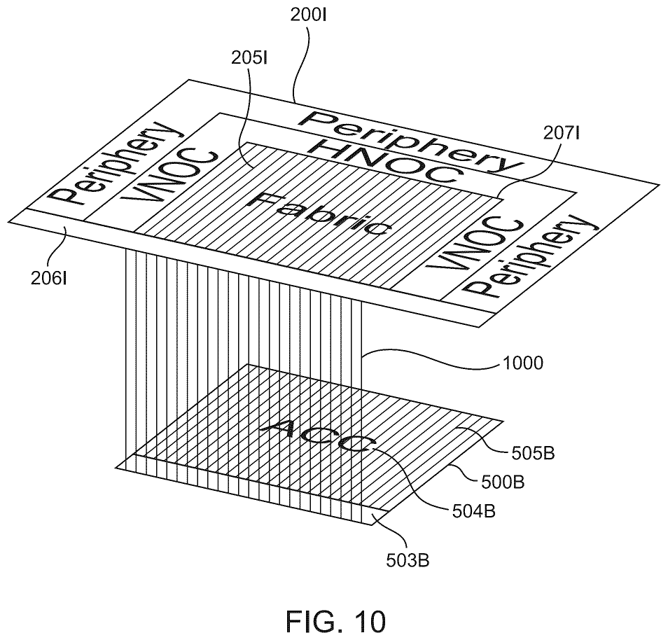

FIG. 10 is a diagram that illustrates a circuit system that includes two integrated circuits (ICs) 200I and 500B that are coupled together through 3 dimensional (3D) interface regions in the ICs. IC 200I is an additional instance of IC 200 of FIG. 2A with a 3D interface region 206I. IC 500B is similar to IC 500A of FIG. 5 in that IC 500B contains an accelerator circuit 504B without VNOCs, peripheral regions, or HNOCs. However, IC 500B has a 3D interface region 503B instead of 2.5D interface region 502A. The embedded fabric NOCs 205I in the fabric region 207I of IC 200I and the embedded NOCs 505B in the accelerator circuit 504B of IC 500B can exchange data with each other through IO buffer circuits in 3D interface region 206I, vertical external conductors 1000, and IO buffer circuits in 3D interface region 503B.

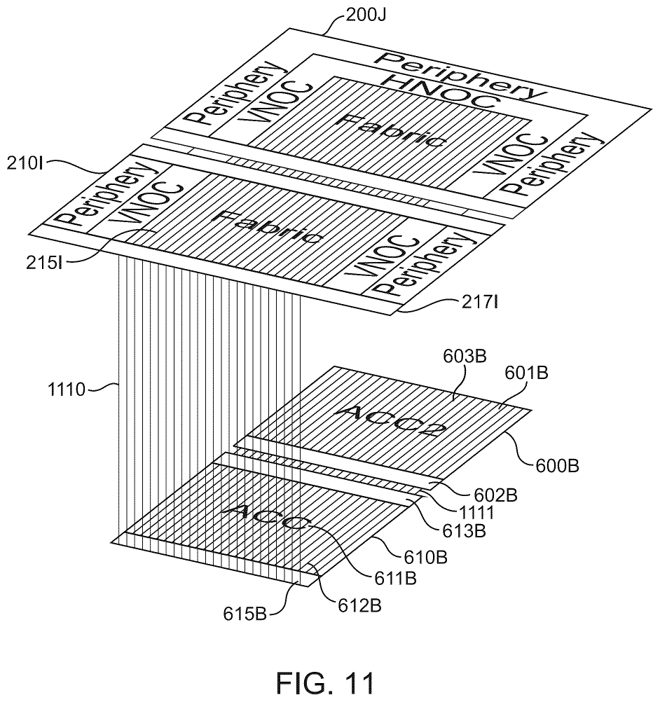

FIG. 11 is a diagram that illustrates a circuit system that includes four integrated circuits (ICs) 200J, 210I, 610B, and 600B that are coupled together through 2.5D and 3D interface regions in the ICs. IC 200J is an additional instance of IC 200 of FIG. 2A. IC 210I is an additional instance of IC 210 of FIG. 2B with 2.5D and 3D interface regions. IC 610B is similar to IC 610A of FIG. 6, but with an additional 3D interface region 615B in place of 2.5D interface region 614A. IC 600B is another instance of IC 600A of FIG. 6.

The VNOCs in ICs 200J and 210I can exchange data with each other through IO buffer circuits in the 2.5D interface regions and external conductors, as disclosed herein for example with respect to FIG. 8. The embedded fabric NOCs in ICs 200J and 210I can exchange data with each other through IO buffer circuits in the 2.5D interface regions and external conductors, as disclosed herein for example with respect to FIG. 8. The embedded fabric NOCs 215I in the fabric region of IC 210I and the embedded NOCs 612B in the accelerator circuit 611B of IC 610B can exchange data with each other through IO buffer circuits in 3D interface region 217I, vertical external conductors 1110, and IO buffer circuits in 3D interface region 615B. The embedded NOCs 603B in accelerator circuit 601B in IC 600B and the embedded NOCs 612B in accelerator circuit 611B in IC 610B can exchange data with each other through IO buffer circuits in 2.5D interface region 602B, external conductors 1111, and IO buffer circuits in 2.5D interface region 613B.

FIG. 12 is a diagram that illustrates a circuit system that includes two integrated circuits (ICs) 100B and 1200 that are coupled together through a 3 dimensional (3D) interface. IC 100B is another instance of IC 100A of FIG. 1. IC 100B includes IO buffer circuits (not shown in FIG. 12) that are in the fabric region of IC 100B. These IO buffer circuits are coupled to a subset of the embedded fabric NOCs 106B in IC 100B and are spaced apart along the lengths of the subset of the embedded fabric NOCs 106B. FIG. 2D illustrates examples of the IO buffer circuits in the fabric region of IC 100B. The IO buffer circuits in the fabric region of IC 100B are coupled to vertical external conductors 1201 arranged in a 3D interface. The IO buffer circuits in the fabric region of IC 100B couple the subset of the embedded fabric NOCs 106B to IC 1200 through the vertical external conductors 1201. As a result, circuits in the fabric region of IC 100B can communicate with and exchange data with circuits in IC 1200 through the subset of the embedded fabric NOCs 106B, the IO buffer circuits coupled to the subset of the embedded fabric NOCs 106B, and vertical external conductors 1201. For example, the subset of the embedded fabric NOCs 106B can be used to access singular addresses in the 3D interface.

Vertical external conductors 1201 create point-to-point connections between the IO buffer circuits in the fabric region of IC 100B and circuitry (e.g., IO buffer circuits) in IC 1200. Vertical external conductors 1201 create a 3D interface across the fabric region of IC 100B that provides a greater spatial reach and a greater signal bandwidth for data transmission between ICs 100B and 1200 compared to the embodiment of FIG. 11, in which the vertical conductors are coupled only to edges of 2 ICs.

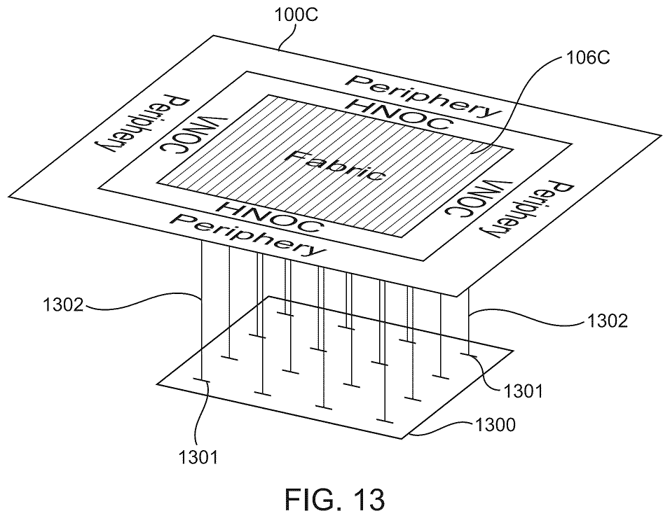

FIG. 13 is a diagram that illustrates a circuit system that includes two ICs 100C and 1300 that are coupled together through a 3D interface. IC 100C is another instance of IC 100A of FIG. 1. IC 100C includes IO buffer circuits (not shown in FIG. 13) in the fabric region of IC 100C. These IO buffer circuits are coupled to a subset of the embedded fabric NOCs 106C of IC 100C and are spaced apart along the lengths of the subset of the embedded fabric NOCs 106C. FIG. 2D illustrates examples of the IO buffer circuits in the fabric region of IC 100C. The IO buffer circuits in the fabric region of IC 100C are coupled to vertical external conductors 1302 arranged in a 3D interface. Vertical external conductors 1302 are also coupled to conductors 1301 in IC 1300. The IO buffer circuits in the fabric region of IC 100C couple the subset of the embedded fabric NOCs 106C to the conductors 1301 in IC 1300 through the vertical external conductors 1302. As a result, circuits in the fabric region of IC 100C can communicate with, and exchange data with, circuits in IC 1300 through the subset of the embedded fabric NOCs 106C, the IO buffer circuits in the fabric region of IC 100C coupled to the subset of the embedded fabric NOCs 106C, vertical external conductors 1302, and conductors 1301 in IC 1300. For example, the subset of the embedded fabric NOCs 106C can be used to access sequential data in any direction through the 3D interface.

Vertical external conductors 1302 create a 3D interface across the fabric region of IC 100C, as discussed above with respect to FIG. 12. The vertical external conductors 1302 create point-to-point connections between the IO buffer circuits in the fabric region of IC 100C and conductors 1301 in IC 1300.

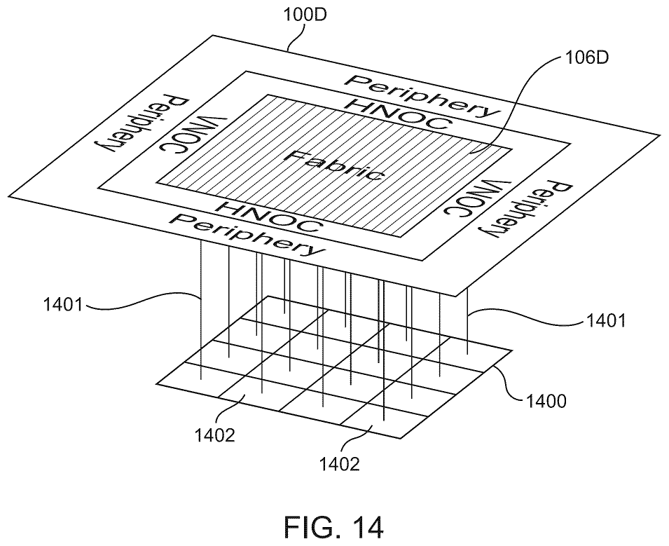

FIG. 14 is a diagram that illustrates a circuit system that includes two ICs 100D and 1400 that are coupled together through a 3D interface. IC 100D is another instance of IC 100A of FIG. 1. IC 100D includes IO buffer circuits (not shown in FIG. 14) in the fabric region of IC 100D. These IO buffer circuits are coupled to a subset of the embedded fabric NOCs 106D of IC 100D and are spaced apart along the lengths of the subset of the embedded fabric NOCs 106D. FIG. 2D illustrates examples of the IO buffer circuits in the fabric region of IC 100D. The IO buffer circuits in the fabric region of IC 100D are coupled to vertical external conductors 1401 arranged in a 3D interface. 16 vertical external conductors 1401 are coupled to 16 segments 1402 of IC 1400. The IO buffer circuits in the fabric region of IC 100D couple the subset of the embedded fabric NOCs 106D to the segments 1402 in IC 1400 through the vertical external conductors 1401. As a result, circuits in the fabric region of IC 100D can communicate with, and exchange data with, circuits in the segments 1402 in IC 1400 through the subset of the embedded fabric NOCs 106D, the IO buffer circuits in the fabric region of IC 100D that are coupled to the subset of the embedded fabric NOCs 106D, and the vertical external conductors 1401. In other embodiments, the segments 1402 can be 16 separate IC dies that exchange data with the circuits in the fabric region of IC 100D through vertical external conductors 1401, the IO buffer circuits in IC 100D, and the subset of the embedded fabric NOCs 106D.

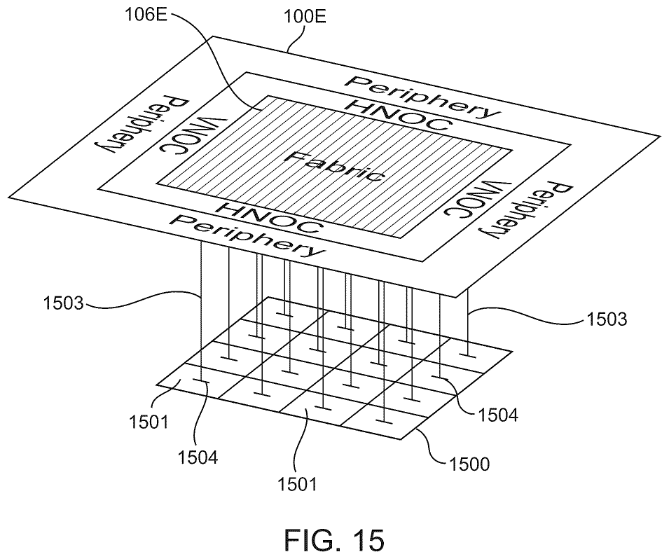

FIG. 15 is a diagram that illustrates a circuit system that includes two ICs 100E and 1500 that are coupled together through a 3D interface. IC 100E is another instance of IC 100A of FIG. 1. IC 100E includes IO buffer circuits (not shown in FIG. 15) in the fabric region of IC 100E. These IO buffer circuits are coupled to a subset of the embedded fabric NOCs 106E of IC 100E and are spaced apart along the lengths of the subset of the embedded fabric NOCs 106E. FIG. 2D illustrates examples of the IO buffer circuits in the fabric region of IC 100E. The IO buffer circuits in the fabric region of IC 100E are coupled to vertical external conductors 1503 arranged in a 3D interface. 16 vertical external conductors 1503 are coupled to 16 segments 1501 of IC 1500. The IO buffer circuits in the fabric region of IC 100E couple the subset of the embedded fabric NOCs 106E to the segments 1501 in IC 1500 through the vertical external conductors 1503 and additional conductors 1504 in each segment 1501 of IC 1500. As a result, circuits in the fabric region of IC 100E can communicate with, and exchange data with, circuits in the segments 1501 in IC 1500 through the subset of the embedded fabric NOCs 106E, the IO buffer circuits coupled to the subset of the embedded fabric NOCs 106E, the vertical external conductors 1503, and conductors 1504. In other embodiments, the segments 1501 can be 16 separate IC dies that exchange data with the circuits in the fabric region of IC 100E through conductors 1504, vertical external conductors 1503, the IO buffer circuits in the fabric region of IC 100E, and the subset of the embedded fabric NOCs 106E.

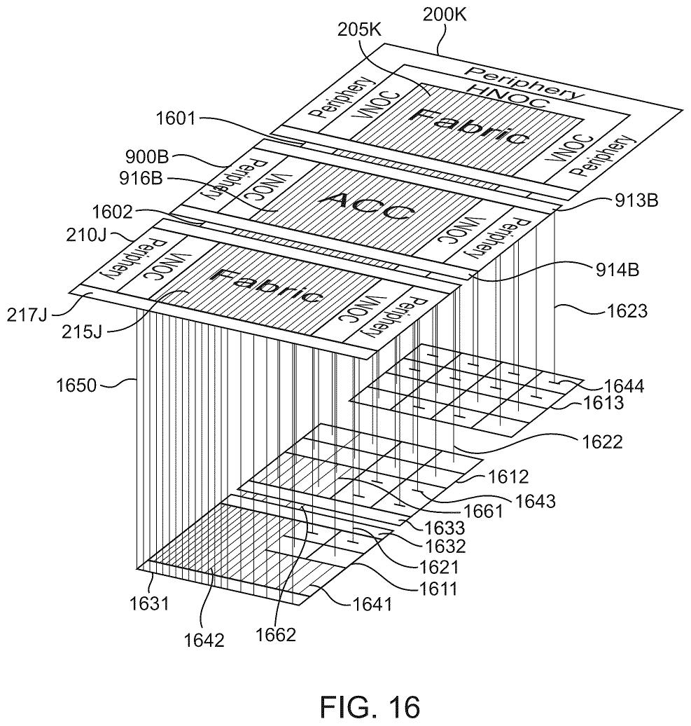

FIG. 16 is a diagram that illustrates a circuit system that includes 6 integrated circuits (ICs) 200K, 900B, 210J, 1611, 1612, and 1613 that are coupled together through 2.5D and 3D interface regions in the ICs. IC 200K is an additional instance of IC 200 of FIG. 2A. IC 210J is an additional instance of IC 210 of FIG. 2B with 2.5D and 3D interface regions. IC 900B is another instance of IC 900A of FIG. 9 that includes 2.5D interface regions 913B and 914B and an accelerator (ACC) circuit. In some embodiments, the 3 ICs 1611, 1612, and 1613 in the circuit system of FIG. 16 are three separate IC dies. In these embodiments, each IC die 1611-1613 includes multiple segments that are part of the IC die. In other embodiments, the segments referred to herein in each of the three ICs 1611, 1612, and 1613 are multiple separate IC dies. Thus, in these embodiments, each IC 1611-1613 includes multiple IC dies that are referred to herein as segments. In other embodiments, circuit systems can include any number of ICs coupled together through 2D and/or 3D interfaces.

The VNOCs in ICs 200K, 900B, and 210J can exchange data with each other through IO buffer circuits in the 2.5D interface regions in these ICs and external conductors 1601-1602, as disclosed herein with respect to previous embodiments. The embedded fabric NOCs 205K in IC 200K, the embedded fabric NOCs 215J in IC 210J, and the embedded NOCs 916B in IC 900B can exchange data with each other through IO buffer circuits in the 2.5D interface regions in these ICs and external conductors 1601-1602, as disclosed herein with respect to previous embodiments.

The embedded fabric NOCs 215J in the fabric region of IC 210J and embedded NOCs 1641 and 1642 in IC 1611 can exchange data with each other through IO buffer circuits in 3D interface region 217J, vertical external conductors 1650, and IO buffer circuits in 3D interface region 1631 in IC 1611. The embedded NOCs 1642 in IC 1611 and embedded NOCs 1661 in IC 1612 can exchange data with each other through IO buffer circuits in 2.5D interface region 1632, external conductors 1662, and IO buffer circuits in 2.5D interface region 1633.

IC 210J includes IO buffer circuits in the fabric region that are coupled to 4 vertical external conductors 1621 that are coupled to 4 segments of IC 1611. Two of the vertical external conductors 1621 are coupled to additional conductors in two of the segments of IC 1611. The IO buffer circuits in the fabric region of IC 210J couple a subset of the embedded fabric NOCs 215J to the 4 segments in IC 1611 through the vertical external conductors 1621 and additional conductors in IC 1611. As a result, circuits in the fabric region of IC 210J can communicate with, and exchange data with, circuits in the 4 segments in IC 1611 through the subset of the embedded fabric NOCs 215J, the IO buffer circuits coupled to the subset of the embedded fabric NOCs 215J, and the vertical external conductors 1621.

IC 900B includes input and output (IO) buffer circuits in the accelerator circuit that are coupled to 16 vertical external conductors 1622. Vertical external conductors 1622 are coupled to 11 segments of IC 1612. Four of the vertical external conductors 1622 are coupled to 4 additional conductors 1643 in 2 of the segments of IC 1612. The IO buffer circuits in the accelerator circuit of IC 900B couple a subset of the embedded NOCs 916B to the 11 segments in IC 1612 through the vertical external conductors 1622, the conductors 1643 in the 2 segments of IC 1612, and conductors 1661 in one segment of IC 1612. As a result, the accelerator circuit of IC 900B can communicate with, and exchange data with, circuits in the 11 segments in IC 1612 through the subset of the embedded NOCs 916B, the IO buffer circuits coupled to the subset of the embedded NOCs 916B, the vertical external conductors 1622, and conductors 1661 and 1643.

IC 200K includes IO buffer circuits in the fabric region that are coupled to 16 vertical external conductors 1623 that are coupled to 16 segments of IC 1613. Ten of the vertical external conductors 1623 are coupled to additional conductors 1644 in 10 of the segments of IC 1613. The IO buffer circuits in the fabric region of IC 200K couple a subset of the embedded fabric NOCs 205K in IC 200K to the 16 segments in IC 1613 through the vertical external conductors 1623 and additional conductors 1644 in IC 1613. As a result, circuits in the fabric region of IC 200K can communicate with, and exchange data with, circuits in the 16 segments in IC 1613 through the subset of the embedded fabric NOCs 205K, the IO buffer circuits coupled to the subset of the embedded fabric NOCs 205K, vertical external conductors 1623, and conductors 1644.

FIG. 17 is a diagram of an illustrative example of a configurable integrated circuit (IC) 1700. Configurable IC 1700 is an example of an IC that can be any of the integrated circuits (ICs) disclosed herein with respect to FIGS. 1-16. As shown in FIG. 17, the configurable integrated circuit 1700 includes a two-dimensional array of configurable logic circuit blocks, including logic array blocks (LABs) 1710 and other configurable logic circuit blocks, such as random access memory (RAM) blocks 1730 and digital signal processing (DSP) blocks 1720, for example. Configurable logic circuit blocks, such as LABs 1710, can include smaller configurable logic circuits (e.g., configurable logic elements, configurable logic blocks, or adaptive logic modules (ALMs)) that receive input signals and perform custom functions on the input signals to produce output signals. The LABs 1710, DSP blocks 1720, and RAM blocks 1730 can be located in a fabric region of the IC 1700 and can be configured to perform any custom user functions. For example, LABs 1710, DSP blocks 1720, and RAM blocks 1730 can be configured as an accelerator circuit.

The configurable integrated circuit 1700 also includes programmable interconnect circuitry in the form of vertical routing channels 1740 (i.e., interconnects formed along a vertical axis of configurable integrated circuit 1700) and horizontal routing channels 1750 (i.e., interconnects formed along a horizontal axis of configurable integrated circuit 1700), each routing channel including at least one track to route at least one wire. One or more of the routing channels 1740 and/or 1750 can be part of a network-on-chip (NOC) having router circuits.

In addition, the configurable integrated circuit 1700 has input/output elements (IOEs) 1702 for driving signals off of configurable integrated circuit 1700 and for receiving signals from other devices. Input/output elements 1702 can include parallel input/output circuitry, serial data transceiver circuitry, differential receiver and transmitter circuitry, or other circuitry used to connect one integrated circuit to another integrated circuit. Input/output elements 1702 can include general purpose input/output (GPIO) circuitry (e.g., on the top and bottoms edges of IC 1700), high-speed input/output (HSIO) circuitry (e.g., on the left edge of IC 1700), and on-package input/output (OPIOs) circuitry (e.g., on the right edge of IC 1700).

As shown, input/output elements 1702 can be located around the periphery of the IC. If desired, the configurable integrated circuit 1700 can have input/output elements 1702 arranged in different ways. For example, input/output elements 1702 can form one or more columns of input/output elements that can be located anywhere on the configurable integrated circuit 1700 (e.g., distributed evenly across the width of the configurable integrated circuit). If desired, input/output elements 1702 can form one or more rows of input/output elements (e.g., distributed across the height of the configurable integrated circuit). Alternatively, input/output elements 1702 can form islands of input/output elements that can be distributed over the surface of the configurable integrated circuit 1700 or clustered in selected areas.

Note that other routing topologies, besides the topology of the interconnect circuitry depicted in FIG. 17, can be used. For example, the routing topology can include wires that travel diagonally or that travel horizontally and vertically along different parts of their extent as well as wires that are perpendicular to the device plane in the case of three dimensional integrated circuits, and the driver of a wire can be located at a different point than one end of a wire. The routing topology can include global wires that span substantially all of configurable integrated circuit 1700, fractional global wires such as wires that span part of configurable integrated circuit 1700, staggered wires of a particular length, smaller local wires, or any other suitable interconnection resource arrangement.

Furthermore, it should be understood that examples disclosed herein may be implemented in any type of integrated circuit. If desired, the functional blocks of such an integrated circuit can be arranged in more levels or layers in which multiple functional blocks are interconnected to form still larger blocks. Other device arrangements can use functional blocks that are not arranged in rows and columns.

Configurable integrated circuit 1700 can also contain programmable memory elements. The memory elements can be loaded with configuration data (also called programming data) using input/output elements (IOEs) 1702. Once loaded, the memory elements each provide a corresponding static control signal that controls the operation of an associated functional block (e.g., LABs 1710, DSP 1720, RAM 1730, or input/output elements 1702).

In a typical scenario, the outputs of the loaded memory elements are applied to the gates of field-effect transistors in a functional block to turn certain transistors on or off and thereby configure the logic in the functional block including the routing paths. Programmable logic circuit elements that are controlled in this way include parts of multiplexers (e.g., multiplexers used for forming routing paths in interconnect circuits), look-up tables, logic arrays, AND, OR, NAND, and NOR logic gates, pass gates, etc.

The memory elements can use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The programmable memory elements can be organized in a configuration memory array consisting of rows and columns. A data register that spans across all columns and an address register that spans across all rows can receive configuration data. The configuration data can be shifted onto the data register. When the appropriate address register is asserted, the data register writes the configuration data to the configuration memory elements of the row that was designated by the address register.

Configurable integrated circuit 1700 can include configuration memory that is organized in sectors, whereby a sector can include the configuration bits that specify the function and/or interconnections of the subcomponents and wires in or crossing that sector. Each sector can include separate data and address registers.

The configurable IC 1700 of FIG. 17 is merely one example of an IC that can be used with embodiments disclosed herein. The embodiments disclosed herein can be used with any suitable electronic integrated circuit or system. For example, the embodiments disclosed herein can be used with numerous types of electronic devices such as processor integrated circuits, central processing units, memory integrated circuits, graphics processing unit integrated circuits, application specific standard products (ASSPs), application specific integrated circuits (ASICs), and configurable logic integrated circuits. Examples of configurable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

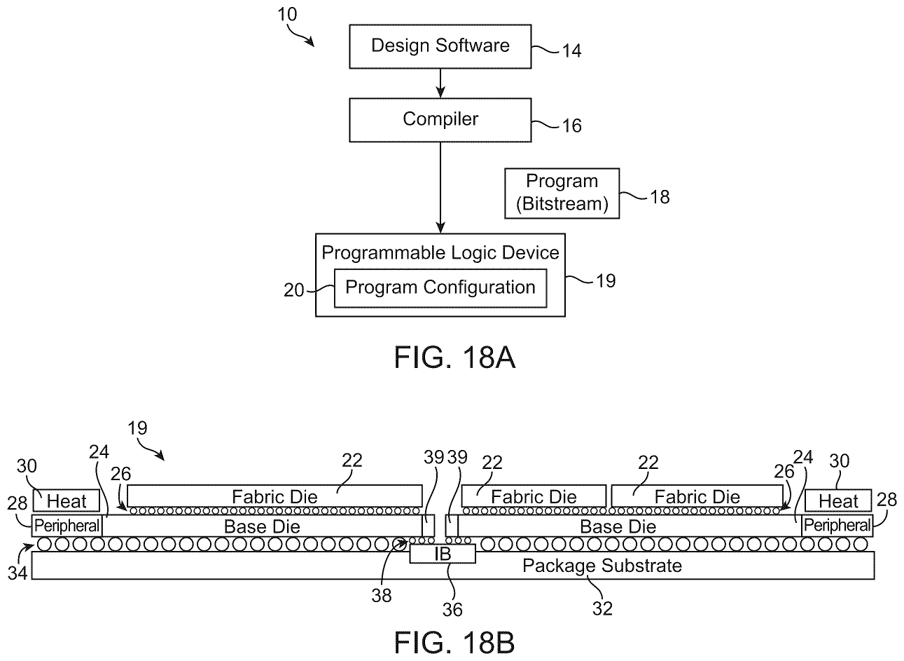

FIG. 18A illustrates a block diagram of a system 10 that can be used to implement a circuit design to be programmed onto a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 18B, but many others can be used, and it should be understood that this disclosure is intended to encompass any suitable programmable logic device where programmable logic fabric and fabric support circuitry are at least partially separated on different integrated circuit die.

FIG. 18B is a diagram that depicts an example of the programmable logic device 19 that includes three fabric die 22 and two base die 24 that are connected to one another via microbumps 26. In the example of FIG. 18B, at least some of the programmable logic fabric of the programmable logic device 19 is in the three fabric die 22, and at least some of the fabric support circuitry that operates the programmable logic fabric is in the two base die 24. For example, some of the circuitry of configurable IC 1700 shown in FIG. 17 (e.g., LABs 1710, DSP 1720, and RAM 1730) can be located in the fabric die 22 and some of the circuitry of IC 1700 (e.g., input/output elements 1702) can be located in the base die 24.

Although the fabric die 22 and base die 24 appear in a one-to-one relationship or a two-to-one relationship in FIG. 18B, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 18B, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

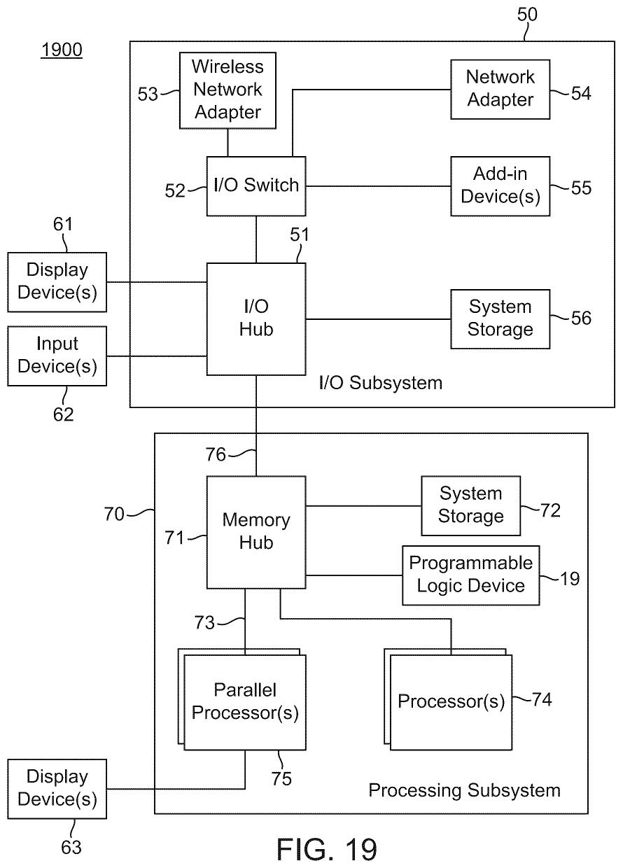

FIG. 19 is a block diagram illustrating a computing system 1900 configured to implement one or more aspects of the embodiments described herein. The computing system 1900 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 1900 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 1900. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 1900 can include other components not shown in FIG. 19, including other port connections, optical storage drives, video capture devices, and the like, that can also be connected to the I/O hub 51. Communication paths interconnecting the various components in FIG. 19 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 1900 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 1900 can be integrated into a single package to form a system in package (SIP) configuration. In one embodiment, at least a portion of the components of the computing system 1900 can be integrated into a multi-chip module (MCM), which can be interconnected with other multi-chip modules into a modular computing system.

The computing system 1900 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 1900. For example, any number of add-in cards or peripherals can be supported, or some components can be eliminated. Furthermore, some architectures can use different terminology for components similar to those illustrated in FIG. 19. For example, the memory hub 71 can be referred to as a Northbridge in some architectures, while the I/O hub 51 can be referred to as a Southbridge.

Additional examples are now described. Example 1 is an integrated circuit comprising: a central region comprising logic circuits and first networks-on-chip, wherein each of the first networks-on-chip traverses the central region; and a first interface region comprising first input and output buffer circuits, wherein the first networks-on-chip are configurable to exchange first data between the logic circuits and the first input and output buffer circuits, wherein a first one of the first networks-on-chip is configurable to place each source that receives the first data from one of the logic circuits at one of multiple locations in the first one of the first networks-on-chip, wherein the first one of the first networks-on-chip is configurable to place each sink that provides the first data to one of the logic circuits at one of the multiple locations in the first one of the first networks-on-chip, wherein the first input and output buffer circuits are coupled to exchange the first data with a first external device, and wherein the first interface region is adjacent to a first edge of the central region.

In Example 2, the integrated circuit of Example 1 further comprises: a second interface region comprising second input and output buffer circuits, wherein the first networks-on-chip are configurable to exchange second data between the logic circuits and the second input and output buffer circuits, wherein a second one of the first networks-on-chip is configurable to place each source that receives the second data from one of the logic circuits at one of the multiple locations in the second one of the first networks-on-chip, wherein the second one of the first networks-on-chip is configurable to place each sink that provides the second data to one of the logic circuits at one of the multiple locations in the second one of the first networks-on-chip, wherein the second input and output buffer circuits are coupled to exchange the second data with a second external device, and wherein the second interface region is adjacent to a second edge of the central region that is opposite the first edge.

In Example 3, the integrated circuit of any one of Examples 1-2 further comprises: second networks-on-chip adjacent to a second edge of the central region; and third networks-on-chip adjacent to a third edge of the central region.

In Example 4, the integrated circuit of any one of Examples 1-3 further comprises: second networks-on-chip adjacent to second, third, and fourth edges of the central region and coupled to exchange second data with the logic circuits through the first networks-on-chip; and a periphery region around the second networks-on-chip.

In Example 5, the integrated circuit of any one of Examples 1˜4 may optionally include, wherein the logic circuits in the central region are configured to function as an accelerator circuit.

In Example 6, the integrated circuit of any one of Examples 1-5 may optionally include, wherein the logic circuits in the central region are configurable logic circuits, and the integrated circuit is a configurable integrated circuit.

In Example 7, the integrated circuit of any one of Examples 1-6 may optionally include, wherein the first interface region is adjacent to a first side of the integrated circuit, and wherein the central region that comprises the logic circuits is adjacent to second, third, and fourth sides of the integrated circuit.

In Example 8, the integrated circuit of any one of Examples 1-7 may optionally include, wherein the first interface region is a 2.5 dimensional interface region.

In Example 9, the integrated circuit of any one of Examples 1-8 may optionally include, wherein the first interface region is a 3 dimensional interface region.

Example 10 is a method for transmitting first and second data in a first integrated circuit, the method comprising: transmitting the first data received from a first logic circuit in a central region of the first integrated circuit at a first source in a first network-on-chip through the first network-on-chip to a first interface region in the first integrated circuit for transmission to a second integrated circuit, wherein the first network-on-chip is configurable to place the first source at one of first locations in the first network-on-chip; and transmitting the second data received from the second integrated circuit at the first interface region through a second network-on-chip to a first sink in the second network-on-chip for transmission to a second logic circuit in the central region, wherein the second network-on-chip is configurable to place the first sink at one of second locations in the second network-on-chip, wherein the first interface region is adjacent to a first edge of the central region, and wherein the first the second networks-on-chip extend across a length of the central region.

In Example 11, the method of Example 10 further comprises: transmitting third data received from a third logic circuit in the central region at a second source in a third network-on-chip through the third network-on-chip to a second interface region in the first integrated circuit for transmission to a third integrated circuit; and transmitting fourth data received from the third integrated circuit at the second interface region through a fourth network-on-chip to a second sink in the fourth network-on-chip for transmission to a fourth logic circuit in the central region, wherein the second interface region is adjacent to a second edge of the central region that is opposite to the first edge, and wherein the third and the fourth networks-on-chip extend across the length of the central region

In Example 12, the method of any one of Examples 10-11 further comprises: operating the first and the second logic circuits in the central region, wherein the first integrated circuit is an application specific integrated circuit.

In Example 13, the method of any one of Examples 10-12 may optionally include, wherein the first interface region is a 2.5 or 3 dimensional interface region.

In Example 14, the method of any one of Examples 10-13 may optionally include, wherein the first and the second logic circuits comprise configurable logic circuits and digital signal processing circuits.

In Example 15, the method of any one of Examples 10-14 may optionally include, wherein the first interface region comprises first input and output buffer circuits, and wherein the first and the second networks-on-chip are parallel to each other.

Example 16 is a circuit system comprising: a first integrated circuit comprising a central region, wherein the central region comprises logic circuits, first networks-on-chip that extend across the central region, and input and output buffer circuits coupled to the first networks-on-chip, wherein the input and output buffer circuits are coupled to exchange data with the logic circuits through the first networks-on-chip, and wherein each one of the first networks-on-chip is configurable to place each source that receives the data from one of the logic circuits and each sink that provides the data to one of the logic circuits at one of multiple locations in that one of the first networks-on-chip; and a second integrated circuit coupled to the first integrated circuit through external conductors arranged in a three dimensional interface, wherein the input and output buffer circuits are coupled to exchange the data with the second integrated circuit through the external conductors.

In Example 17, the circuit system of Example 16 may optionally include, wherein the second integrated circuit comprises second conductors, and wherein each of the second conductors is coupled to one of the external conductors.

In Example 18, the circuit system of any one of Examples 16-17 may optionally include, wherein the second integrated circuit comprises segments, and wherein each of the segments is coupled to one of the external conductors.

In Example 19, the circuit system of any one of Examples 16-18 may optionally include, wherein the first networks-on-chip are parallel to each other.

In Example 20, the circuit system of any one of Examples 16-19 may optionally include, wherein the first integrated circuit further comprises second and third networks-on-chip that are each adjacent to an edge of the central region and are coupled to the first networks-on-chip.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit comprising:
a central region comprising logic circuits and first networks-on-chip, wherein each of the first networks-on-chip traverses the central region; and
a first interface region comprising first input and output buffer circuits, wherein the first networks-on-chip are configurable to exchange first data between the logic circuits and the first input and output buffer circuits, wherein a first one of the first networks-on-chip is configurable to place each source that receives the first data from one of the logic circuits at one of multiple locations in the first one of the first networks-on-chip, wherein the first one of the first networks-on-chip is configurable to place each sink that provides the first data to one of the logic circuits at one of the multiple locations in the first one of the first networks-on-chip, wherein the first input and output buffer circuits are coupled to exchange the first data with a first external device, and wherein the first interface region is adjacent to a first edge of the central region.

2. The integrated circuit of claim 1 further comprising:
a second interface region comprising second input and output buffer circuits, wherein the first networks-on-chip are configurable to exchange second data between the logic circuits and the second input and output buffer circuits, wherein a second one of the first networks-on-chip is configurable to place each source that receives the second data from one of the logic circuits at one of the multiple locations in the second one of the first networks-on-chip, wherein the second one of the first networks-on-chip is configurable to place each sink that provides the second data to one of the logic circuits at one of the multiple locations in the second one of the first networks-on-chip, wherein the second input and output buffer circuits are coupled to exchange the second data with a second external device, and wherein the second interface region is adjacent to a second edge of the central region that is opposite the first edge.

3. The integrated circuit of claim 1 further comprising:
second networks-on-chip adjacent to a second edge of the central region; and
third networks-on-chip adjacent to a third edge of the central region.

4. The integrated circuit of claim 1 further comprising:
second networks-on-chip adjacent to second, third, and fourth edges of the central region and coupled to exchange second data with the logic circuits through the first networks-on-chip; and
a periphery region around the second networks-on-chip.

5. The integrated circuit of claim 1, wherein the logic circuits in the central region are configured to function as an accelerator circuit.

6. The integrated circuit of claim 1, wherein the logic circuits in the central region are configurable logic circuits, and the integrated circuit is a configurable integrated circuit.

7. The integrated circuit of claim 1, wherein the first interface region is adjacent to a first side of the integrated circuit, and wherein the central region that comprises the logic circuits is adjacent to second, third, and fourth sides of the integrated circuit.

8. The integrated circuit of claim 1, wherein the first interface region is a 2.5 dimensional interface region.

9. The integrated circuit of claim 1, wherein the first interface region is a 3 dimensional interface region.

10. A method for transmitting first and second data in a first integrated circuit, the method comprising:
transmitting the first data received from a first logic circuit in a central region of the first integrated circuit at a first source in a first network-on-chip through the first network-on-chip to a first interface region in the first integrated circuit for transmission to a second integrated circuit, wherein the first network-on-chip is configurable to place the first source at one of first locations in the first network-on-chip; and
transmitting the second data received from the second integrated circuit at the first interface region through a second network-on-chip to a first sink in the second network-on-chip for transmission to a second logic circuit in the central region, wherein the second network-on-chip is configurable to place the first sink at one of second locations in the second network-on-chip, wherein the first interface region is adjacent to a first edge of the central region, and wherein the first and the second networks-on-chip extend across a length of the central region.

11. The method of claim 10 further comprising:
transmitting third data received from a third logic circuit in the central region at a second source in a third network-on-chip through the third network-on-chip to a second interface region in the first integrated circuit for transmission to a third integrated circuit; and
transmitting fourth data received from the third integrated circuit at the second interface region through a fourth network-on-chip to a second sink in the fourth network-on-chip for transmission to a fourth logic circuit in the central region, wherein the second interface region is adjacent to a second edge of the central region that is opposite to the first edge, and wherein the third and the fourth networks-on-chip extend across the length of the central region.

12. The method of claim 10 further comprising:
operating the first and the second logic circuits in the central region, wherein the first integrated circuit is an application specific integrated circuit.

13. The method of claim 10, wherein the first interface region is a 2.5 or 3 dimensional interface region.

14. The method of claim 10, wherein the first and the second logic circuits comprise configurable logic circuits and digital signal processing circuits in the first integrated circuit.

15. The method of claim 10, wherein the first interface region comprises first input and output buffer circuits, and wherein the first and the second networks-on-chip are parallel to each other.

16. A circuit system comprising:
a first integrated circuit comprising a central region, wherein the central region comprises logic circuits, first networks-on-chip that extend across the central region, and input and output buffer circuits coupled to the first networks-on-chip, wherein the input and output buffer circuits are coupled to exchange data with the logic circuits through the first networks-on-chip, and wherein each one of the first networks-on-chip is configurable to place each source that receives the data from one of the logic circuits and each sink that provides the data to one of the logic circuits at one of multiple locations in that one of the first networks-on-chip; and
a second integrated circuit coupled to the first integrated circuit through external conductors arranged in a three dimensional interface, wherein the input and output buffer circuits are coupled to exchange the data with the second integrated circuit through the external conductors.

17. The circuit system of claim 16, wherein the second integrated circuit comprises second conductors, and wherein each of the second conductors is coupled to one of the external conductors.

18. The circuit system of claim 16, wherein the second integrated circuit comprises segments, and wherein each of the segments is coupled to one of the external conductors.

19. The circuit system of claim 16, wherein the first networks-on-chip are parallel to each other.

20. The circuit system of claim 16, wherein the first integrated circuit further comprises second and third networks-on-chip that are each adjacent to an edge of the central region and are coupled to the first networks-on-chip.
